(19) United States
(12) Patent Application Publication
(10) Pub. No.: US 2026/0257537 A1
(43) Pub. Date: Sep. 3, 2026

(54) FLUID MODULE FOR AUTOMOTIVE THERMAL MANAGEMENT

(71) Applicant: HANON SYSTEMS, Daejeon (KR)

(72) Inventors: In Keun KANG, Daejeon (KR); Seung Kyu OH, Daejeon (KR); Kyeong Cheol LEE, Daejeon (KR); Jae Min LEE, Daejeon (KR); Young Wook CHO, Daejeon (KR)

(21) Appl. No.: 19/163,885

(22) PCT Filed: Apr. 18, 2024
(86) PCT No.: PCT/KR2024/005237

§ 371 Date: Sep. 10, 2025

(30) Foreign Application Priority Data
Apr. 20, 2023 (KR) 10-2023-0052152
Apr. 16, 2024 (KR) 10-2024-0050831

(51) Int. Cl. B60H 1/32; B60H 1/00

(52) U.S. Cl. CPC B60H 1/3229; B60H 1/00278; B60H 1/00385

(57) ABSTRACT

An embodiment relates to a manifold plate having a plurality of fluidic paths formed therein, wherein a portion where fluid flowing in from an outdoor heat exchanger flows into the manifold plate may be disposed at a relatively lower position than a portion where the fluid flows out from the manifold plate to an evaporator.

### TECHNICAL FIELD

The present invention relates to a fluid module for automotive thermal management, and more specifically, to a fluid module for automotive thermal management in which a heat exchanger and valve components are modularized as one component.

### BACKGROUND ART

According to the trend toward environmentally friendly industrial development and the development of energy sources that replace fossil raw materials, electric vehicles and hybrid vehicles are fields that have been attracting the most attention in the automobile industry in recent years. In electric vehicles and hybrid vehicles, batteries are mounted and provide driving forces, and the batteries are used for not only driving but also cooling and heating.

In a vehicle in which batteries are used to provide a driving force, using the batteries as a heat source for heating and cooling means that a driving distance is reduced by as much as the used amount. In order to overcome the above-described problems, a method of applying a thermal management system, which is conventionally and widely used as a home air conditioning and heating system, to a vehicle has been proposed.

For reference, a thermal management system absorbs heat at a low temperature and transfers the absorbed heat to an area at a high temperature. An example of the thermal management system has a cycle in which a liquid fluid evaporates in an evaporator, absorbs heat from surroundings to become a gas, and then emits heat to the surroundings using a condenser to be liquified. When this is applied to an electric vehicle or hybrid vehicle, there is an advantage of securing a heat source which is insufficient in the conventional general air conditioner.

In a current thermal management system for an electric vehicle, main components (a valve, an accumulator, a chiller, a condenser, an internal heat exchanger, a sensor, and the like) are connected through pipes in a partial modularization manner. Development of a technology capable of properly arranging components, optimizing modularization through upgrading a refrigerant flow path and the like and minimizing thermal interference is needed during a process of developing such a thermal management system for a vehicle.

### DETAILED DESCRIPTION OF INVENTION

### Technical Problem

One embodiment of the present invention is directed to providing a fluid module for automotive thermal management, in which a third flow path through which a medium temperature fluid flows is disposed between a first flow path through which a low temperature fluid flows and a second flow path through which a high temperature fluid flows to minimize thermal interference.

In addition, one embodiment of the present invention is directed to providing a fluid module for automotive thermal management, of which a structure is simply changed such that an inlet flange is disposed below an outlet flange in a gravity direction to prevent a fluid from flowing backward so as to prevent generation of fluid and oil traps and occurrence of unnecessary pressure loss in a pipe.

In addition, one embodiment of the present invention is directed to providing a fluid module for automotive thermal management, which allows the fluid module for automotive thermal management to be packaged so as to improve the workability of a product and reduce a cost because a fluid flowing along the other surface of a manifold plate is directly introduced into a valve through a main plate.

### Technical Solution

A fluid module for automotive thermal management according to one embodiment of the present invention includes a manifold plate in which a plurality of fluid flow paths are formed, wherein a portion at which a fluid is introduced into the manifold plate from an outdoor heat exchanger may be disposed at a relatively lower location than a portion at which the fluid is introduced into an evaporator from the manifold plate.

One surface of the manifold plate may include an inlet flange into which the fluid heat-exchanged in the outdoor heat exchanger is introduced, the one surface of the manifold plate may include an outlet flange from which the fluid is discharged to the evaporator; and the inlet flange may be disposed at a lower location than the outlet flange in a gravity direction.

The fluid flow paths may include a first flow path through which a high temperature fluid flows and a second flow path through which a low temperature fluid flows, wherein a third flow path through which a medium temperature fluid flows may be formed between the inlet flange and the outlet flange.

The first flow path may be formed in the one surface of the manifold plate, and the second flow path may be formed in the other surface of the manifold plate.

The third flow path may be formed in the one surface of the manifold plate together with the second flow path.

The third flow path may be formed in one surface of the manifold plate, in which the first flow path or the second flow path among the first flow path or the second flow path is formed, wherein a temperature difference between the fluids flowing therethrough may be small.

A temperature difference between the fluid flowing through the second flow path and the fluid flowing through the third flow path may be smaller than a temperature difference between the fluid flowing through the first flow path and the fluid flowing through the third flow path.

The fluid introduced into one surface of the manifold plate from the outdoor heat exchanger may be directly introduced into a valve coupled to the other surface of the manifold plate.

A heat exchanger, in which a refrigerant and cooling water are heat-exchanged with each other, and a valve may be coupled to the one surface of the manifold plate, and the heat exchanger and the valve may be coupled to the one surface of the manifold plate in which the first flow path is formed.

A cooling water pipe through which the cooling water is introduced and discharged in the heat exchanger may be disposed in a separation space between the first flow path and the second flow path.

The heat exchanger may be a battery chiller.

The first flow path and the second flow path may be disposed to be spaced apart from each other in the manifold plate.

The third flow path may be formed in the one surface of the manifold plate together with the first flow path.

The first flow path and the second flow path may be disposed at farthest sides in the manifold plate, and the third flow path may be disposed between the first flow path and the second flow path.

A fluid module for automotive thermal management according to another embodiment of the present invention includes a manifold plate in which a plurality of fluid flow paths are formed, wherein a fluid flow path may be formed between a portion at which a fluid is introduced into the manifold plate from an outdoor heat exchanger and a portion at which the fluid is discharged to an evaporator from the manifold plate, and at least a portion of the fluid flow path may be formed to be located at a lower location.

One surface of the manifold plate may include an inlet flange into which the fluid heat-exchanged in the outdoor heat exchanger is introduced, the one surface of the manifold plate may include an outlet flange from which the fluid is discharged to the evaporator, and the fluid flow path may be formed between the inlet flange and the outlet flange.

The manifold plate may include a first flow path through which a high temperature fluid flows and a second flow path through which a low temperature fluid flows, wherein a third flow path through which a medium temperature fluid flows may be formed between the inlet flange and the outlet flange.

### Advantageous Effects

According to one embodiment of the present invention, since a third flow path through which a medium temperature fluid flows is disposed between a first flow path through which a low temperature fluid flows and a second flow path through which a high temperature fluid flows, thermal interference can be minimized.

In addition, according to one embodiment of the present invention, since a structure is simply changed such that an inlet flange is disposed below an outlet flange in a gravity direction to prevent a fluid from flowing backward, generation of fluid and oil traps and occurrence of unnecessary pressure loss in a pipe can be prevented.

In addition, according to one embodiment of the present invention, since a fluid flowing along the other surface of a manifold plate can pass through a main plate and can be directly introduced into a valve, a fluid module for automotive thermal management can be packaged to improve the workability of a product and reduce a cost.

### DESCRIPTION OF DRAWINGS

FIG. 1 is a perspective view illustrating a fluid module for automotive thermal management according to one embodiment of the present invention.

FIG. 2 is a rear perspective view illustrating the fluid module for automotive thermal management according to one embodiment of the present invention.

FIG. 3 is a side view illustrating the fluid module for automotive thermal management according to one embodiment of the present invention.

FIG. 4 is a view illustrating a structure of a third flow path of the fluid module for automotive thermal management according to another embodiment of the present invention.

FIG. 5 is a view illustrating a fluid flow in a cooling mode of the fluid module for automotive thermal management according to one embodiment of the present invention.

FIG. 6 is a view illustrating a fluid flow in a heating mode of the fluid module for automotive thermal management according to one embodiment of the present invention.

FIG. 7 is a view illustrating a pipe connected to the fluid module for automotive thermal management according to one embodiment of the present invention.

FIG. 8 is a view illustrating operation in the cooling mode of the fluid module for automotive thermal management according to one embodiment of the present invention.

FIG. 9 is a view illustrating operation in the heating mode of the fluid module for automotive thermal management according to one embodiment of the present invention.

### MODE OF THE INVENTION

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the present invention.

Terms such as “first” and “second” may be used to describe various components, but the components are not limited by the above terms. These terms are used only to distinguish one component from another.

Terms used herein are only for the purpose of describing the specific embodiments and are not intended to limit the present invention. Singular forms are intended to include the plural forms, unless the context clearly indicates otherwise. In the present specification, it should be understood that the terms “comprise,” “comprising,” “include,” and/or “including” specify the presence of stated features, numbers, steps, operations, elements, components, and/or combinations thereof but do not preclude the presence or addition of one or more other features, numbers, steps, operations, elements, components, and/or combinations thereof.

In addition, throughout the specification, when components are “connected,” this may not only mean that two or more components are directly connected but may also mean that two or more components are indirectly connected through other components, physically connected and also electrically connected, or integrated as one component even when referred to by different names according to locations or functions thereof.

Hereinafter, one embodiment of a fluid module for automotive thermal management will be described in detail with reference to the accompanying drawings, and when the embodiment is described with reference to the accompanying drawings, components that are the same or correspond to each other will be denoted by the same reference numerals, and redundant description thereof will be omitted.

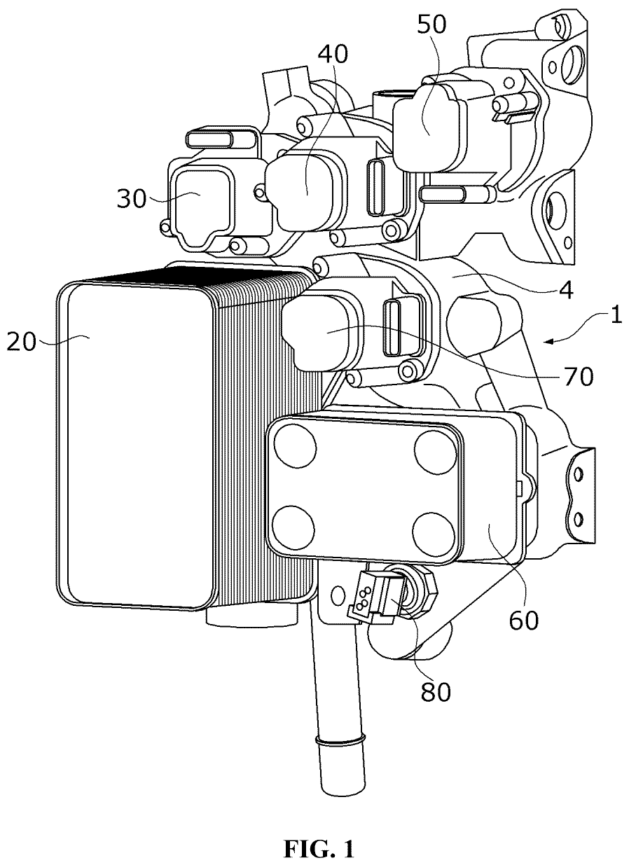

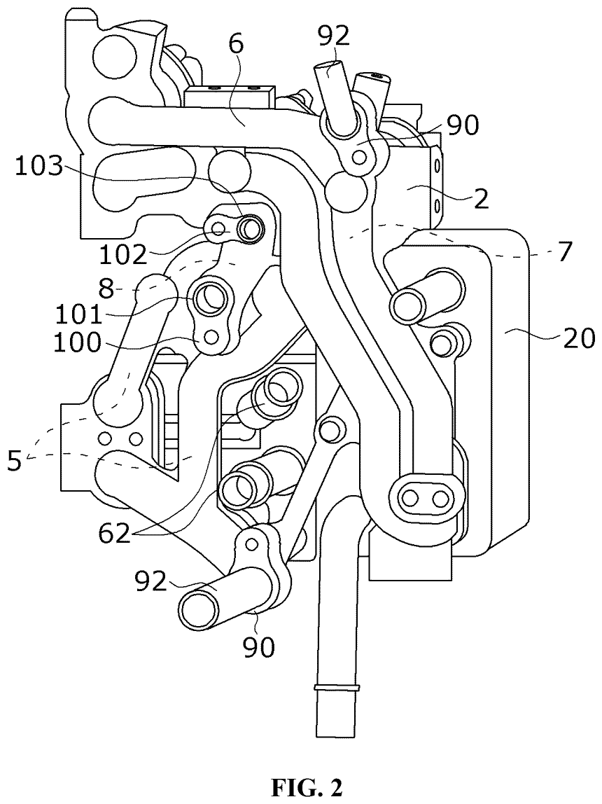

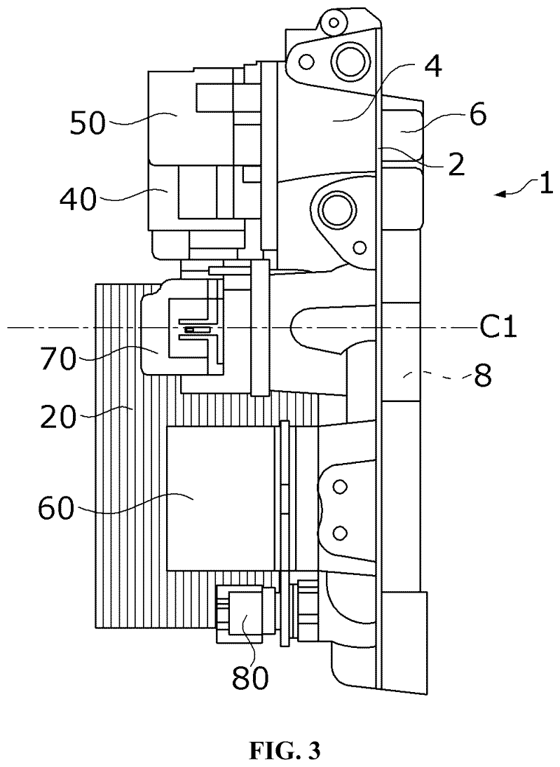

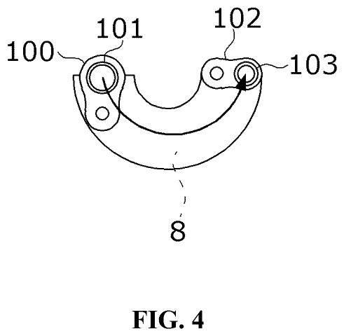

FIG. 1 is a perspective view illustrating a fluid module for automotive thermal management according to one embodiment of the present invention, and FIG. 2 is a rear perspective view illustrating the fluid module for automotive thermal management according to one embodiment of the present invention. FIG. 3 is a side view illustrating the fluid module for automotive thermal management according to one embodiment of the present invention, and FIG. 4 is a view illustrating a structure of a third flow path of the fluid module for automotive thermal management according to another embodiment of the present invention.

According to the illustrated drawings, the fluid module for automotive thermal management according to one embodiment of the present invention may include a manifold plate 1 in which a plurality of fluid flow paths are formed, the fluid flow paths include a first flow path 5 through which a low temperature fluid flows and a second flow path 7 through which a high temperature fluid flows, and a fluid discharged toward an evaporator 112 from the manifold plate 1 may flow along a third flow path 8 disposed between the first flow path 5 and the second flow path 7.

The manifold plate 1 has a substantially plate shape in which the fluid flow paths are formed and has a predetermined thickness. As a first heat exchanger 20, a second heat exchanger 60, expansion valves 30 and 70, and direction change valves 40 and 50, which are heat exchange apparatuses of a thermal management system, are coupled to and modularized with the manifold plate 1, a product manufacturing man-hour can be reduced, and a man-hour of a vehicle assembly line can also be reduced. In addition, since the manifold plate 1 serves functions of piping, fitting, and housing simultaneously, costs can be reduced, and workability can be improved.

The manifold plate 1 may include a main plate 2, a first plate 4 which is coupled to one surface of the main plate 2 and in which a flow path through which the fluid flows is formed, and a second plate 6 which is coupled to the other surface of the main plate 2 and in which a flow path through which the fluid flows is formed. The manifold plate 1 may include an assembly including the above-described plates and may be manufactured in a method of coupling using brazing, structural adhesives, a gasket, etc. In addition, aluminum, thermos-plastic, or stainless steel may be variously applied as a material of the first manifold plate 1 according to objectives and functions.

The main plate 2 may be formed in a plate shape, the first plate 4 may be coupled to one surface of the main plate 2, and the second plate 6 may be coupled to the other surface thereof. As the first plate 4 and the second plate 6 are coupled to protrude predetermined thicknesses, the fluid flow paths are formed between the first plate 4 and second plate 6 and the main plate 2. According to the manifold plate 1 formed through the coupling described above, since the heat exchangers, valves, and the like may be coupled to both surfaces of the main plate 2 and the fluid flow paths may be formed, components can be modularized in a more compact space.

A refrigerant and cooling water, which are heat exchange fluids, may perform heat exchange while passing through the first heat exchanger 20 and the second heat exchanger 60. In the present embodiment, a water cooling condenser may be used as the first heat exchanger 20, and a chiller may be used as the second heat exchanger 60. The water cooling condenser serves a high temperature and high pressure gaseous fluid (refrigerant) discharged from a compressor or internal condenser to be heat-exchanged with external heat to condense the high temperature and high pressure gaseous fluid (refrigerant) into a high pressure liquid. The chiller is an apparatus to which a low temperature and low pressure fluid is supplied and in which the low temperature and low pressure fluid is heat-exchanged with cooling water flowing through a cooling water circulation line (not shown), and the cold cooling water heat-exchanged in the chiller may circulate the cooling water circulation path and may be heat-exchanged with a battery.

The first expansion valve 30 serves to control expansion of the fluid introduced into the first heat exchanger 20. The first expansion valve 30 may be disposed around the first heat exchanger 20 and may allow the fluid introduced into the fluid module for automotive thermal management to expand or pass therethrough. The fluid introduced through the first expansion valve 30 may perform heat exchange while passing through the first heat exchanger 20 or flow to an external heat exchanger.

The fluid discharged through the first heat exchanger 20 is introduced into a first direction change valve 40. The first direction change valve 40 serves to control a flow direction of the fluid discharged from the first heat exchanger 20. The fluid introduced into the first direction change valve 40 may flow to an outdoor heat exchanger 110. In addition, the fluid introduced into the first expansion valve 30 may flow to a second direction change valve 50, and then flow to the evaporator 112 in a dehumidification mode.

The sensor 80 (such as a PT sensor) which measures a temperature and a pressure of the fluid may be disposed on the first flow path 5 through which the fluid discharged from the second heat exchanger 60 flows. This is to detect an accurate state (a temperature and a pressure) of the fluid discharged from the second heat exchanger 60 and improve controllability of a chiller expansion valve (not shown). In the present embodiment, the sensor 80 may be coupled to one surface of the manifold plate 1, that is, the first plate 4. That is, the sensor 80 and other components may be coupled to one surface of the manifold plate 1.

In the present embodiment, as components, of which frequencies of after service (A/S) are relatively high, such as the valves are disposed on one surface of the manifold plate 1 corresponding to an opposite side of an engine room, that is, a front surface, a worker may easily perform A/S by separating only the corresponding valve from the manifold plate 1 for A/S. In addition, as components, of which frequencies of A/S are relatively low, such as a pipe 92 are disposed on the other surface of the manifold plate 1 corresponding to a surface facing the engine room, that is, a rear surface, a space is compact. In addition, connection flanges 90 may be provided various locations on the other surface of the manifold plate 1 such that the pipe 92 directly communicates with the fluid flow paths.

The first flow path 5 through which the fluid flows may be formed in the first plate 4, and the second flow path 7 and the third flow path 8 through which the fluid flows may be formed in the second plate 6. Accordingly, the fluid may flow along the first plate 4 and the second plate 6 disposed at both sides of the main plate 2.

The fluid flowing through the manifold plate 1 may have a low temperature portion through which the low temperature fluid flows and a high temperature portion through which the high temperature fluid flows, and thermal interference may occur between the low temperature portion and the high temperature portion. Accordingly, in the present embodiment, the third flow path 8 through which the fluid of a medium temperature range flows is formed between the first flow path 5 and the second flow path 7.

The first flow path 5 may be formed in one surface of the manifold plate 1 coupled to the heat exchangers and the valves which will be described below. Since the low temperature fluid flows through the first flow path 5, the first flow path 5 and the heat exchangers and valves may be disposed in the same one surface.

In the present embodiment, the first flow path 5 and the second flow path 7 may be disposed in separate spaces in the manifold plate 1. As one embodiment, the first flow path 5 and the second flow path 7 may be disposed at farthest sides in the manifold plate 1, and the third flow path 8 may be disposed between the first flow path 5 and the second flow path 7. For example, the first flow path 5 may be disposed along an upper portion and a side portion of the manifold plate 1. The second flow path 7 may be disposed along a lower portion and the side portion of the manifold plate 1. In addition, the third flow path 8 may be disposed in a separation space formed between the first flow path 5 and the second flow path 7.

A cooling water pipe 62 through which the cooling water is introduced into and discharged from the second heat exchanger 60 may be disposed in the separation space between the first flow path 5 and the second flow path 7. Such an arrangement of the cooling water pipe 62 is to reduce a package of the coupled components of the manifold plate 1. The cooling water pipe 62 is formed to extend and pass through from the second heat exchanger 60 coupled to one surface of the manifold plate 1 toward the other surface of the manifold plate 1.

Since a temperature of the third flow path 8 is relatively lower than the high temperature fluid flowing through the second flow path 7, in the present embodiment, the third flow path 8 is disposed between the first flow path 5 and the second flow path 7 to minimize thermal interference. In addition, since a temperature difference between the fluid flowing through the third flow path 8 and the high temperature fluid flowing through the second flow path 7 is smaller than a temperature difference between the fluid flowing through the third flow path 8 and the low temperature fluid flowing through the first flow path 5, the third flow path 8 may be formed in the second plate 6 in which the second flow path 7 is formed. However, when a temperature difference between the fluid flowing through the third flow path 8 and the fluid flowing through the first flow path 5 is small, the third flow path 8 may also be disposed in the first plate 4.

In the present embodiment, the third flow path 8 may be a flow path through which the fluid introduced from the outdoor heat exchanger 110 flows to be discharged toward the evaporator 112. However, the third flow path 8 may be another flow path instead of the above-described flow path of the fluid. For example, the third flow path 8 may be a flow path of the fluid flowing through a medium temperature region instead of the high temperature portion and the low temperature portion formed in one region of the manifold plate 1. The third flow path 8 may be formed between a third flow path inlet port 101 through which the fluid introduced from the outdoor heat exchanger 110 is introduced and a third flow path outlet port 103 through which the fluid is discharged toward the evaporator 112. The third flow path inlet port 101 may be formed in an inlet flange 100, and the third flow path outlet port 103 may be formed in an outlet flange 102.

Referring to FIG. 3, the fluid introduced from the outdoor heat exchanger 110 may be introduced through the second plate 6 and introduced into a second expansion valve 70 disposed at an opposite side thereof. The inlet flange 100 through which the fluid is introduced and the second expansion valve 70 may be disposed on an extension line C1 extending in a horizontal direction. That is, the fluid introduced into the manifold plate 1 through the inlet flange 100 passes through the main plate 2 and is directly introduced into the second expansion valve 70 located at the opposite side. When the fluid flow path is formed as described above, a structure of the flow path can be simplified, pressure loss occurring while the fluid passes through a relatively long flow path can be reduced, and a package of the fluid module can be reduced.

The above-described second expansion valve 70 is one example, and any valve as long as being disposed in each of the first plate 4 and the second plate 6 based on the main plate 2 may be formed such that fluid flow paths directly communicate with the valve through the main plate 2.

As described above, the third flow path 8 may be the flow path through which the fluid introduced into the inlet flange 100 from the outdoor heat exchanger 110 is discharged to the outlet flange 102. In this case, the inlet flange 100 may be relatively disposed at a lower location than the outlet flange 102. That is, the inlet flange 100 may be disposed at a lower location than the outlet flange 102 in the gravity direction. In this case, the fluid expanding in the second expansion valve 70 may flow toward an accumulator 114 (low temperature region) in a heating mode, and a problem that the fluid flows backward through the third flow path 8 which connects the inlet flange 100 and the outlet flange 102 may occur. That is, a problem that the fluid flows backward and is introduced toward the evaporator 112 through the outlet flange 102 may occur.

Accordingly, in the present embodiment, as the inlet flange 100 is disposed below the outlet flange 102, there is a height difference such that the fluid is not discharged to the outlet flange 102 even when the fluid flows from the inlet flange 100 through the third flow path 8. In addition, a stopping step may be formed or a check valve may be installed in the third flow path 8 in order to prevent backflow of the fluid in the third flow path 8. Since a structure is simply changed such that the inlet flange 100 is disposed below the outlet flange 102 to prevent the fluid from flowing backward as described above, generation of fluid and oil traps and occurrence of unnecessary pressure loss in a pipe 120 can be prevented.

One example of a structure of the inlet flange 100 and the outlet flange 102 of the manifold plate 1 has been described above, the present invention is not limited thereto, and a structure in which a fluid is directly introduced through a hole, etc. formed in one surface of the manifold plate 1 may also be implemented.

In addition, referring to FIG. 4, at least of a portion of the third flow path 8 may be formed to be located at a lower side. That is, since the at least a portion of the third flow path 8 is formed to be bent downward, the fluid may be prevented from flowing backward toward the outlet flange 102. In this case, the inlet flange 100 does not need to be located below the outlet flange 102 and may be disposed at the same level.

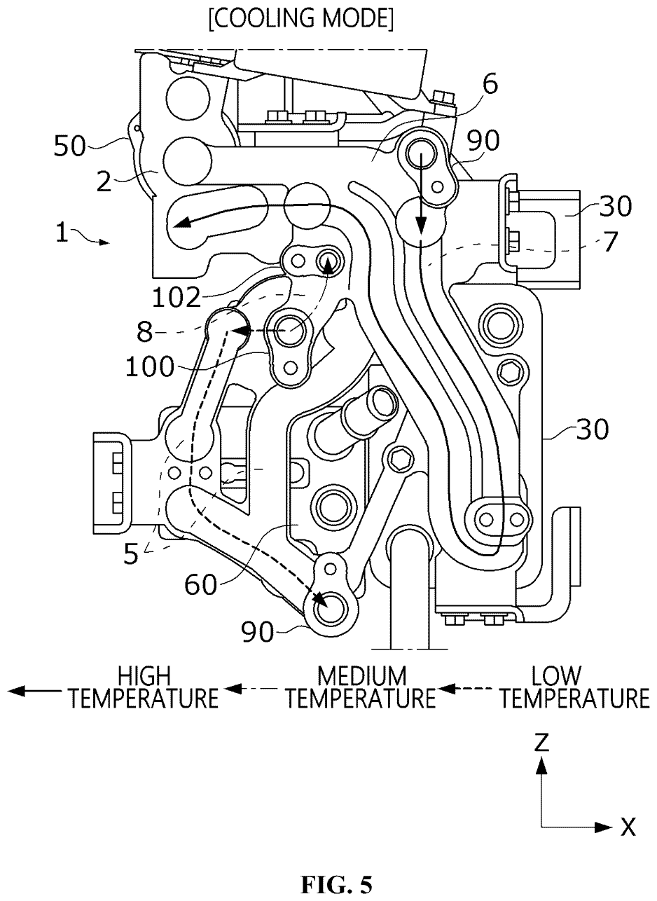

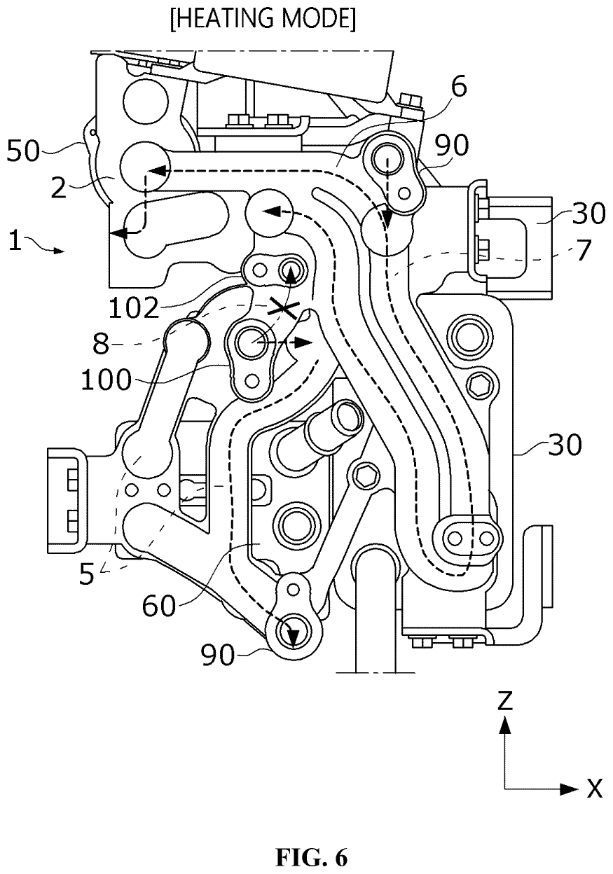

FIG. 5 is a view illustrating a fluid flow in a cooling mode of the fluid module for automotive thermal management according to one embodiment of the present invention, and FIG. 6 is a view illustrating a fluid flow in a heating mode of the fluid module for automotive thermal management according to one embodiment of the present invention.

Referring to FIG. 5, in the cooling mode, the high temperature fluid introduced into the manifold plate 1 is heat-exchanged with the cooling water in the first heat exchanger 20 while passing through the second flow path 7 and is introduced into the first direction change valve 40. The first direction change valve 40 may control the fluid discharged from the first heat exchanger 20 to flow to the outdoor heat exchanger 110.

Next, the fluid discharged from the outdoor heat exchanger 110 is introduced into the manifold plate 1 through the inlet flange 100. The fluid is introduced into the second expansion valve 70 disposed at the opposite side and then flows through the first flow path 5. In this case, the fluid is heat-exchanged with the cooling water while passing through the second heat exchanger 60. The fluid may be discharged toward the accumulator 114 through a connection flange 90 disposed at the lowermost end of the manifold plate 1.

In addition, the fluid introduced into the inlet flange 100 may be discharged through the third flow path 8 and the outlet flange 102. The fluid discharged to the outlet flange 102 may be introduced toward the evaporator 112 through the pipe 120. In this case, as the third flow path 8 is disposed between the first flow path 5 and the second flow path 7, occurrence of thermal interference can be minimized.

Referring to FIG. 6, in the heating mode, the fluid is introduced into the first heat exchanger 20 from the first expansion valve 30, performs heat exchange, and then is introduced into the first direction change valve 40. The fluid passing through the first direction change valve 40 may flow through the first flow path 5 and then may be discharged toward the accumulator 114 through the connection flange 90 disposed at the lowermost end of the manifold plate 1. In addition, some of the fluid passing through the first expansion valve 30 may be introduced into the outdoor heat exchanger 110.

Meanwhile, the fluid discharged from the outdoor heat exchanger 110 is introduced through the inlet flange 100 and then flows through the first flow path 5. In the heating mode, the fluid discharged from the outdoor heat exchanger 110 is introduced into the manifold plate 1 and then flows through only the first flow path 5 flowing toward the accumulator 114. That is, since the fluid does not flow through the third flow path 8 formed toward the outlet flange 102, the fluid introduced into the outlet flange 102 should be prevented from flowing backward. In the present embodiment, as the inlet flange 100 is disposed at the location relatively below the outlet flange 102, the fluid introduced into the outlet flange 102 can be prevented from flowing backward.

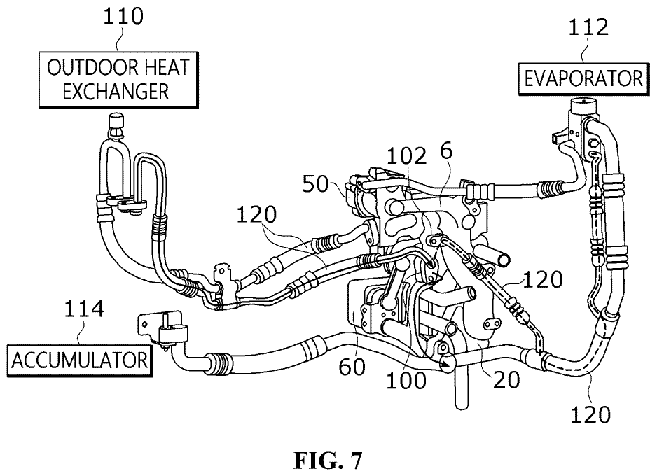

FIG. 7 is a view illustrating the pipe connected to the fluid module for automotive thermal management according to one embodiment of the present invention.

In the fluid module for automotive thermal management, the outdoor heat exchanger 110, the evaporator 112, and the accumulator 114 may be connected to each other through the pipe 120 around the manifold plate 1.

In this case, a fluid flow path drawn with a solid line indicates that the fluid flows normally, and a fluid flow path drawn with a dotted line indicates that the fluid flows backward. Referring to this, since the fluid flows backward toward the evaporator 112 when the fluid flows backward through the outlet flange 102, fluid and oil traps may be generated and unnecessary pressure loss may occur in the pipe 120. Accordingly, in the present embodiment, in order to prevent a backflow of the fluid, there is the height difference between the inlet flange 100 and the outlet flange 102.

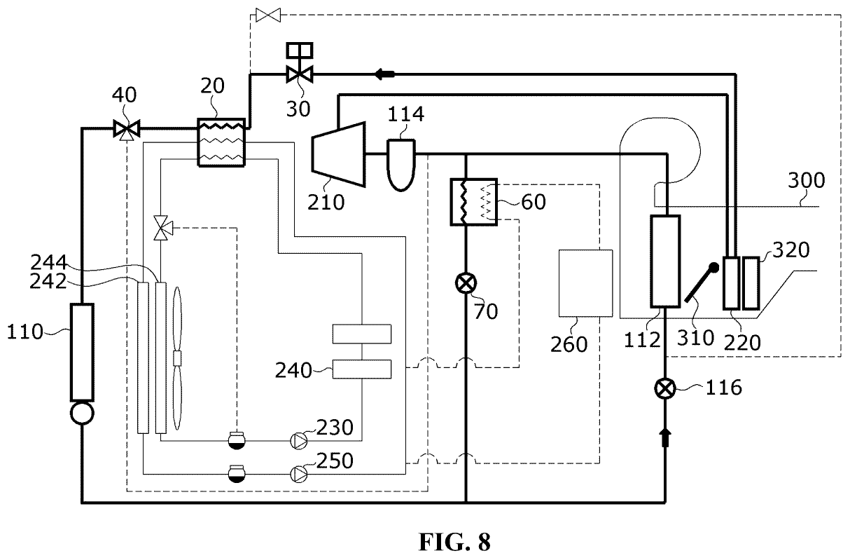

FIG. 8 is a view illustrating operation in the cooling mode of the fluid module for automotive thermal management according to one embodiment of the present invention.

Referring to FIG. 8, a compressor 210 operates to discharge the high temperature and high pressure refrigerant from the compressor 210. The refrigerant discharged from the compressor 210 passes through a condenser 220 and the first expansion valve 30 in a non-expansion state.

The refrigerant passing through the first expansion valve 30 is heat-exchanged with the cooling water while passing through the first heat exchanger 20. In addition, the refrigerant passing through the first direction change valve 40 is introduced into the outdoor heat exchanger 110 and heat-exchanged with external air. In this case, the refrigerant discharged from the outdoor heat exchanger 110 is introduced into the third flow path 8 through the third flow path inlet port 101 of the inlet flange 100.

Some of the refrigerant introduced into the third flow path 8 expands in the third expansion valve 116, then is introduced into the evaporator 112, and is heat-exchanged. The refrigerant heat-exchanged in the evaporator 112 cools air while being heat-exchanged with the air flowing in an air conditioning case 300 and evaporating, and the cooled air is supplied to a vehicle interior to cool the vehicle interior. The refrigerant heat-exchanged in the evaporator 112 is introduced back into the compressor 210 through the accumulator 114. In the air conditioning case 300, a temperature adjusting door 310, which adjusts an amount of air bypassing the condenser 220 and an amount of air passing through the condenser 220, may be installed between the evaporator 112 and the condenser 220.

Meanwhile, the remaining refrigerant of the refrigerant discharged from the outdoor heat exchanger 110 expands in the second expansion valve 70, then is introduced into the second heat exchanger 60, and is heat-exchanged with the cooling water. The refrigerant heat-exchanged in the second heat exchanger 60 is introduced back into the compressor 210 through the accumulator 114.

In the cooling mode, since the high temperature of the refrigerant passing through the outdoor heat exchanger 110 is lowered to a medium temperature and then lowered to a low temperature while passing through the second expansion valve 70, there is a problem of thermal interference. Accordingly, in the present embodiment, the second flow path 7 through which the refrigerant passing through the second expansion valve 70 flows is disposed to be spaced apart from the first flow path 5 through which the high temperature refrigerant flows and the third flow path 8 through which the medium temperature refrigerant flows.

Meanwhile, one line of the cooling waters is circulated by operation of a water pump 230. The circulating cooling water performs heat exchange while passing through the first heat exchanger 20 and a radiator 244, and thus an electric component 240 is cooled.

The cooling water of another line of the cooling water lines is circulated by operation of a water pump 250. The circulating cooling water performs heat exchange while passing through the first heat exchanger 20 and a radiator 242.

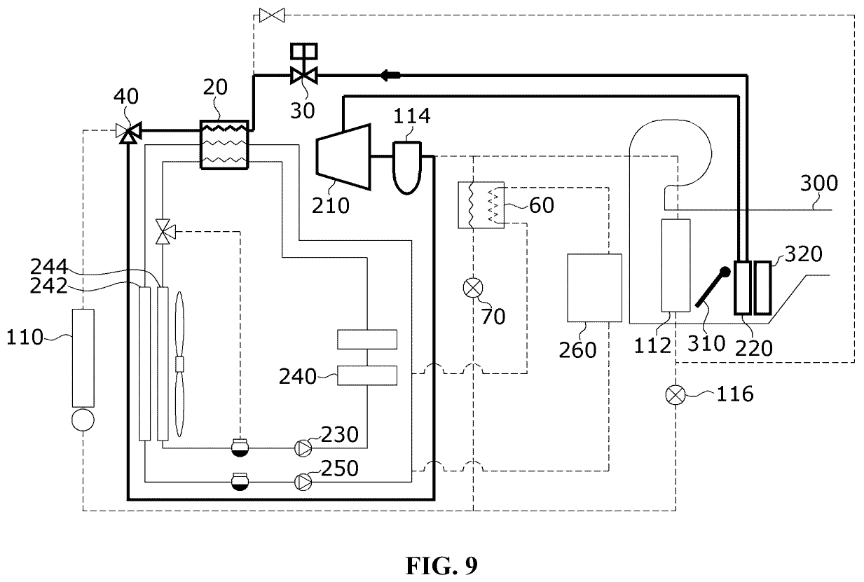

FIG. 9 is a view illustrating operation in the heating mode of the fluid module for automotive thermal management according to one embodiment of the present invention.

Referring to FIG. 9, the compressor 210 operates to discharge the high temperature and high pressure refrigerant from the compressor 210. The refrigerant discharged from the compressor 210 is heat-exchanged with air flowing in the air conditioning case 300 while passing through the condenser 220, and air heated by a positive temperature coefficient (PTC) heater 320 may warm air that is supplied to the vehicle interior to perform heating.

The refrigerant passing through the condenser 220 expands while passing through the first expansion valve 30, and the refrigerant passing through the first expansion valve 30 is heat-exchanged with the cooling water and condensed while passing through the first heat exchanger 20. In addition, the first direction change valve 40 closes the outdoor heat exchanger 110 and opens the accumulator 114. Accordingly, the refrigerant may be introduced back into the compressor 210 from the first heat exchanger 20 through the accumulator 114.

Meanwhile, one line of the cooling waters is circulated by operation of the water pump 230. The circulating cooling water performs heat exchange while passing through the first heat exchanger 20 and the radiator 244, and thus the electric component 240 is cooled. Circulation of the cooling water of another line of the cooling water lines may be selectively performed.

While the present invention has been described above with reference to exemplary embodiments, it may be understood by those skilled in the art that various modifications and changes of the present invention may be made within a range not departing from the spirit and scope of the present invention defined by the appended claims.

[Reference Numerals]

| | |
|---|---|
| 1: MANIFOLD PLATE | 2: MAIN PLATE |
| 4: FIRST PLATE | 5: FIRST FLOW PATH |
| 6: SECOND PLATE | 7: SECOND FLOW PATH |
| 8: THIRD FLOW PATH | 20: FIRST HEAT EXCHANGER |
| 30: FIRST EXPANSION VALVE | 40: FIRST DIRECTION CHANGE |
| | VALVE |
| 50: SECOND DIRECTION | 60: SECOND HEAT |
| CHANGE VALVE | EXCHANGER |
| 62: COOLING WATER PIPE | 70: SECOND EXPANSION |
| | VALVE |
| 80: SENSOR | 90: CONNECTION FLANGE |
| 92: PIPE | 100: INLET FLANGE |
| 101: THIRD FLOW PATH INLET | 102: OUTLET FLANGE |
| PORT | |
| 103: THIRD FLOW PATH OUTLET | 110: OUTDOOR HEAT |
| PORT | EXCHANGER |
| 112: EVAPORATOR | 114: ACCUMULATOR |
| 116: THIRD EXPANSION VALVE | 210: COMPRESSOR |
| 220: CONDENSER | 230: WATER PUMP |
| 240: ELECTRIC COMPONENT | 242: RADIATOR |
| 244: RADIATOR | 250: WATER PUMP |
| 260: BATTERY | 300: AIR CONDITIONING CASE |
| 310: TEMPERATURE ADJUSTING | 320: PTC HEATER |
| DOOR | |

1. A fluid module for automotive thermal management, comprising a manifold plate in which a plurality of fluid flow paths are formed,
wherein a portion at which a fluid is introduced into the manifold plate from an outdoor heat exchanger is disposed at a relatively lower location than a portion at which the fluid is discharged to an evaporator from the manifold plate.

2. The fluid module of claim 1, wherein:
one surface of the manifold plate includes an inlet flange into which the fluid heat-exchanged in the outdoor heat exchanger is introduced;
the one surface of the manifold plate includes an outlet flange from which the fluid is discharged to the evaporator; and
the inlet flange is disposed at a lower location than the outlet flange in a gravity direction.

3. The fluid module of claim 2, wherein the fluid flow paths include:
a first flow path through which a high temperature fluid flows; and
a second flow path through which a low temperature fluid flows,
wherein a third flow path through which a medium temperature fluid flows is formed between the inlet flange and the outlet flange.

4. The fluid module of claim 3, wherein:
the first flow path is formed in the one surface of the manifold plate; and
the second flow path is formed in the other surface of the manifold plate.

5. The fluid module of claim 4, wherein the third flow path is formed in the one surface of the manifold plate together with the second flow path.

6. The fluid module of claim 3, wherein the third flow path is formed in one surface of the manifold plate, in which the first flow path or the second flow path among the first flow path and the second flow path is formed, wherein a temperature difference between the fluids flowing therethrough is relatively small.

7. The fluid module of claim 3, wherein a temperature difference between the fluid flowing through the second flow path and the fluid flowing through the third flow path is smaller than a temperature difference between the fluid flowing through the first flow path and the fluid flowing through the third flow path.

8. The fluid module of claim 1, wherein the fluid introduced into one surface of the manifold plate from the outdoor heat exchanger is directly introduced into a valve coupled to the other surface of the manifold plate.

9. The fluid module of claim 3, wherein:
a heat exchanger, in which a refrigerant and cooling water are heat-exchanged with each other, and a valve are coupled to the one surface of the manifold plate; and
the heat exchanger and the valve are coupled to the one surface of the manifold plate in which the first flow path is formed.

10. The fluid module of claim 9, wherein a cooling water pipe through which the cooling water is introduced and discharged in the heat exchanger is disposed in a separation space between the first flow path and the second flow path.

11. The fluid module of claim 10, wherein the heat exchanger includes a battery chiller.

12. The fluid module of claim 3, wherein the first flow path and the second flow path are disposed to be spaced apart from each other in the manifold plate.

13. The fluid module of claim 3, wherein the third flow path is formed in the one surface of the manifold plate together with the first flow path.

14. The fluid module of claim 3, wherein:
the first flow path and the second flow path are disposed at farthest sides in the manifold plate; and
the third flow path is disposed between the first flow path and the second flow path.

15. A fluid module for automotive thermal management, comprising a manifold plate in which a plurality of fluid flow paths are formed,
wherein a fluid flow path is formed between a portion at which a fluid is introduced into the manifold plate from an outdoor heat exchanger and a portion at which the fluid is discharged to an evaporator from the manifold plate, and
at least a portion of the fluid flow path is formed to be located at a lower location.

16. The fluid module of claim 15, wherein:
one surface of the manifold plate includes an inlet flange into which the fluid heat-exchanged in the outdoor heat exchanger is introduced;
the one surface of the manifold plate includes an outlet flange from which the fluid is discharged to the evaporator; and
the fluid flow path is formed between the inlet flange and the outlet flange.

17. The fluid module of claim 16, wherein the manifold plate includes:
a first flow path through which a high temperature fluid flows: and
a second flow path through which a low temperature fluid flows,
wherein a third flow path through which a medium temperature fluid flows is formed between the inlet flange and the outlet flange.
